(19) United States
(12) Patent Application Publication
(10) Pub. No.: US 2023/0222817 A1
(43) Pub. Date: Jul. 13, 2023

(54) METHOD AND APPARATUS FOR 3D OBJECT DETECTION AND SEGMENTATION BASED ON STEREO VISION

(71) Applicant: Nokia Technologies Oy, Espoo (FI)

(72) Inventor: Hanqing SUN, Tianjin (CN)

(21) Appl. No.: 18/001,548

(22) PCT Filed: Jul. 3, 2020
(86) PCT No.: PCT/CN2020/100136

§ 371 Date: Dec. 12, 2022

(51) Int. Cl. G06V 20/64; G06V 10/40; G06V 10/26; G06V 10/82; G06T 7/55; G06V 10/77; G06T 7/11

(52) U.S. Cl. CPC G06V 20/64; G06V 10/40; G06V 10/26; G06V 10/82; G06T 7/55; G06V 10/7715; G06T 7/11; G06T 2207/20084; G06T 2207/20016

(57) ABSTRACT

A method, apparatus and system for 3D object detection and segmentation are provided. The method comprises the steps of: extracting multi-view 2D features based on multi-view images captured by a plurality of cameras; generating a 3D feature volume based on the multi-view 2D features; and performing a depth estimation, a semantic segmentation, and a 3D object detection based on the 3D feature volume. The method, apparatus, and system of the disclosure are faster, computation friendly, flexible, and more practical to deploy on vehicles, drones, robots, vehicles, mobile devices, or mobile communication devices.

### FIELD OF THE INVENTION

The present disclosure generally relates to image pattern recognition, and more specifically, to a method and device for three-dimension (3D) object detection and segmentation based on stereo vision.

### BACKGROUND

Perception of 3D environment is essential in robotics, especially in autonomous driving, drones, and unmanned surface vehicles. To obtain 3D information, methods based on monocular vision systems, stereo vision systems, and LiDAR (Light Detection and Ranging) point clouds are studied but not fully applied. Monocular vision systems are developing rapidly with the help of recent NN (Neural Networks) technique but can hardly estimate accurate 3D information. Stereo vision, including multi-view stereo vision, is a classic computer vision topic which can give more accurate 3D information using epipolar geometry. Parallel to camera-based vision systems, various NN models have also been designed to detect 3D object from point clouds obtained by a LiDAR device.

The CNN (Convolutional Neural Network) technique has been helping methods in those three categories which are developed rapidly in recent years. 2D CNN is widely used in monocular-based algorithms and is the dominating technique in 2D object detection and segmentation. 3D CNN is a common choice to detect or segment 3D object in LiDAR-based methods. In stereo vision methods, CNN technique is showing its great potential in depth estimation and 3D object detection, but it is hardly fully studied in simultaneous 3D object detection and segmentation.

Some solutions in prior art rely highly on accurate 3D information captured by LiDARs and provide 3D detection, tracking and motion forecasting in point cloud sequences in an end-to-end manner. For example, Semantic SLAM (Simultaneous Localization and Mapping) methods, which focuses on building high resolution maps with semantic labels, can only perform semantic segmentation and are mainly based on monocular vision systems.

Some techniques perform 3D object detection in monocular vision, stereo vision, and LiDAR systems, respectively. For example, SMOKE is a single-stage monocular 3D object detector which is validated on the KITTI dataset with an AP (average precision) of 9.76%. DSGN network is a recent 3D object detector for stereo vision systems which can achieve an AP of 52.18%.

Known vision-based 2D perception is challenging to be extended to those 3D applications due to the lack of the depth dimension. The LiDAR, which can provide accurate 3D coordinates, is neither affordable for mass production nor capable of capturing visual features as much as a camera can. Consequently, stereo vision systems are of great potential to fulfill the 3D perception demands of various autonomous robots and vehicles.

In addition, there are not many prior methods that can simultaneously detect and segment 3D objects. The 3D object detection and segmentation system with faster speed and more functionalities is an upcoming demand in advanced autonomous robots and vehicles.

Thus, there is a need for improving the method and apparatus for 3D object detection and segmentation based on stereo vision.

### SUMMARY

To overcome the problem described above, and to overcome the limitations that will be apparent upon reading and understanding the prior arts, the embodiments of the disclosure provide a method, apparatus, and system for 3D object detection and segmentation.

According to the first aspect of the disclosure, a method for 3D object detection and segmentation is provided. The method comprises: extracting multi-view 2D features based on multi-view images captured by a plurality of cameras; generating a 3D feature volume based on the multi-view 2D features; and performing a depth estimation, a semantic segmentation, and a 3D object detection based on the 3D feature volume.

According to the second aspect of the disclosure, an apparatus for 3D object detection and segmentation is provided. The apparatus comprises: a multi-view 2D feature extraction module configured to extract multi-view 2D features based on multi-view images captured by a plurality of cameras; a 3D feature volume generation module configured to generate a 3D feature volume based on the multi-view 2D features; and a 3D object detection and segmentation module configured to perform a depth estimation, a semantic segmentation, and a 3D object detection based on the 3D feature volume.

According to the third aspect of the disclosure, a non-transitory computer-readable storage medium is provided. The non-transitory computer-readable storage medium stores instructions which, when executed by one or more processor, cause the processor to perform a method as mentioned above.

According to the fourth aspect of the disclosure, a vehicle or a mobile communication device comprising the apparatus as mentioned above is provided.

According to the fifth aspect of the disclosure, a method for 3D object detection and segmentation is provided. The method comprises: receiving multi-view images captured by a plurality of cameras; using a trained neural network for: extracting multi-view 2D features based on the multi-view images; generating a 3D feature volume based on the multi-view 2D features; and performing a depth estimation, a semantic segmentation, and a 3D object detection based on the 3D feature volume.

According to sixth aspect of the disclosure, an apparatus for 3D object detection and segmentation is provided. The apparatus comprises: at least one processor; at least one memory including computer program code; wherein the at least one memory and the computer program code are configured to, with the at least one processor, cause the apparatus at least to: receive multi-view images captured by a plurality of cameras; and use a trained neural network stored in the at least one memory at least to extract multi-view 2D features based on the multi-view images, generate a 3D feature volume based on the multi-view 2D features, and perform a depth estimation, a semantic segmentation, and a 3D object detection based on the 3D feature volume.

The method, apparatus, and system provided in this disclosure are related to a visual perception system for various vehicles, robots, drones, vessels, mobile devices, and/or mobile communication devices. It estimates depth, classifies pixels (semantic segmentation), detects 3D objects, and segments 3D instance in stereo vision based on a hybrid 2D and 3D CNN model design, which has not been accomplished using conventional CNN models. In contrast with most prior 3D object detectors based on LiDAR point clouds, the system according to the embodiments of the disclosure is based on stereo vision systems (including binocular stereo and multi-view stereo). Unlike prior 2D object detection and segmentation methods that give results on the image coordinate system, the method, apparatus, and system of the disclosure directly output 3D detection and segmentation results on the Cartesian coordinate system.

From the perspective of system integration, the method, apparatus, and system of the disclosure are more practical, more flexible, and more scalable than prior arts. The unified CNN model design for 3D detection and segmentation leads to fast inference and makes it possible to be incorporated in applications, such as a real-time autonomous application. The solutions of the disclosure are flexible for detecting 3D object instance at any height, instead of merely detecting object on the ground in most prior approaches. In addition, the CNN model in the disclosure is end-to-end trainable.

Still other aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details may be modified in various obvious respects, all without departing from the spirit and scope of the disclosure. Accordingly, the drawings and description are to be regarded as illustrative in nature, and not as restrictive.

### BRIEF DESCRIPTION OF THE DRAWINGS

The exemplary embodiments of the disclosure are illustrated by way of example, and not by way of limitation, in the figures of the accompanying drawings:

FIG. 1 illustrates an exemplary diagram of the overall CNN architecture for 3D object detection and segmentation based on stereo vision according to an embodiment of the disclosure;

FIG. 2 illustrates an exemplary flow chart of the method for 3D object detection and segmentation based on stereo vision according to an embodiment of the disclosure;

FIG. 3 illustrates an exemplary application in a vehicle for 3D object detection and segmentation based on stereo vision according to an embodiment of the disclosure;

FIG. 4 illustrates an another application in an end device or a client device for 3D object detection and segmentation based on stereo vision according to an embodiment of the disclosure; and

FIG. 5 illustrate an exemplary computer system or apparatus for implementing the method for 3D object detection and segmentation based on stereo vision according to an embodiment of the disclosure.

### DETAILED DESCRIPTION OF THE INVENTION

The disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

Despite some basic concepts that can be extracted from prior arts, there are lots of new designs in this disclosure to meet the challenging and developing requirements of 3D object detection and segmentation in an open world.

The functionalities of 3D object detection and segmentation by the method, apparatus and system according to the embodiments of this disclosure are new in the context of CNN-based stereo vision. This task requires classify pixels in images (semantic segmentation), detect 3D objects, and segment 3D instance. It is not a simple extension on 2D detection and segmentation: the minimum bound rectangle of a 2D instance segmentation patch is identical to its 2D detection bounding box, while a 3D instance segmentation patch may not lead to a unique 3D detection box because of the obscure caused by view projection and overlapping.

The provided method, apparatus, and system can be used for detecting any objects, on either binocular or multi-view stereo vision systems, indoor or outdoor. However, the description exemplarily illustrates the technical details by stating how it is implemented on a binocular stereo vision system as a 3D vehicle detection and segmentation system for autonomous driving cars. The ordinary technicians will note that the solutions can be easily extended to multi-view stereo vision systems according to the basic concept of the disclosure.

The technical details about the system according to embodiments of the disclosure are introduced below with reference to an exemplary overcall CNN architecture of the disclosure. It is noted that CNN network is one type of Neutral Network, which provides better processing performance and is commonly used for many contexts of artificial intelligence and machine learning. The present description selects CNN networks as the basic NN to illustrate the concept of the disclosure, but the solutions according to embodiments of the disclosure are not limited to CNN networks and is applicable to any deep neural network (DNN).

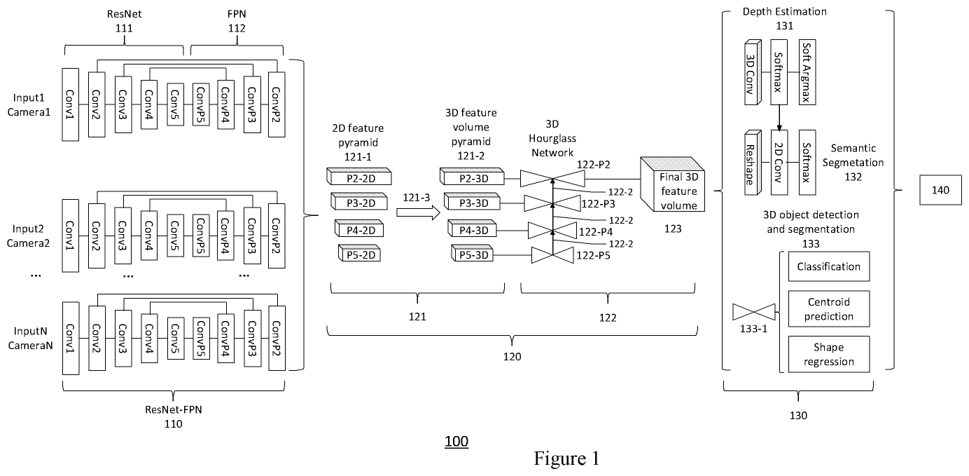

As shown in FIG. 1, an overcall hybrid 2D and 3D CNN model system for 3D object detection and segmentation based on stereo vision according to an embodiment of the disclosure comprises three modules of a multi-view 2D feature extraction module 110, a 3D feature volume generation module 120, and a 3D object detection and segmentation module 130, in general.

The multi-view 2D feature extraction module 110 is configured to extract multi-view 2D features based on the multi-view images captured by a plurality of cameras. In an exemplary embodiment, the multi-view 2D feature extraction module 110 comprises three ResNet-FPN networks with feature extraction. However, two or more of the ResNet-FPN networks with the feature extraction can be implemented. The images can be still images provided by a still image camera, and/or a stream of images provided by a video camera. Therefore, the camera in this disclosure comprises still image camera(s) and/or video camera(s) that capture still images and/or streams of images.

The number of the ResNet-FPN networks corresponds to the number of the cameras used in the system or apparatus. For example, the upper ResNet-FPN network of the multi-view 2D feature extraction module 110 in FIG. 1 receives the inputted multi-view 2D image(s) Input1 captured by Camera1; the second ResNet-FPN network under the upper ResNet-FPN network receives the inputted multi-view 2D image(s) Input captured by Camera2; . . . ; and the lowest ResNet-FPN network receives the inputted multi-view 2D image(s) InputN captured by CameraN.

Each of the ResNet-FPN networks comprises a ResNet network 111 and a corresponding FPN (Feature Pyramid Network) network 112 connected to each other and is configured to extract a multi-view 2D feature based on the multi-view 2D images captured by respective one of Camera1 to CameraN. The ResNet network is a stereo ResNet-50 network with feature extraction, for example. The feature extractor may use GroupNorm algorithm, for example.

The ResNet network 111 comprises a plurality of groups of convolutional layers. For example, in FIG. 1, the ResNet network 111 comprises five groups of convolutional layers of Conv1, Conv2, . . . , Conv5 connected in sequence. Each group of the convolutional layers comprises a plurality of convolutional layers. The first group of the convolutional layers Conv1, as the input group of convolutional layers of the ResNet 111, may comprise several convolutional layers, such as a number below ten of convolutional layers. The other groups of the convolutional layers Conv2 to Conv5 may comprise more convolutional layers, such as over ten of convolutional layers. The groups of Conv1 to Conv5 perform a down-sampling by processing the inputted multi-view 2D image(s) from each of the cameras, that is, from the group of the Conv1 to the group of the Conv5, they receive the inputted feature maps of the multi-view 2D image(s) that have gradually reduced resolutions or correspond and/or process different feature maps with gradually reduced resolutions. For example, the first group of the Conv1 receives the inputted multi-view 2D image(s) with original resolution, the second group of the Conv2 receives the feature map with ¼ (½ *½) of the original resolution as outputted by the first group of the Conv1, the third group of the Conv3 receives the feature map with ⅛ (½ *½ *½) resolution of the original resolution as outputted by the second group of the Conv2, and so on. The gradually reduced resolution of outputted feature map can reduce the calculation work if selected properly.

Similar to the ResNet network 111, the FPN network 112 comprises a plurality of groups of convolutional layers too. For example, the FPN network 112 comprises four groups of convolutional layers of ConvP2, ConvP3, . . . , ConvP5 connected in sequence. Each group of the convolutional layers comprises one convolutional layer or a plurality of convolutional layers. According to an embodiment of the disclosure, the outputs (activations) of each group of convolutional layers Conv2 to Conv5 of the ResNet network 111 are fed into the inputs of corresponding group of the convolutional layers ConvP2 to ConvP5 of the FPN network 112, respectively. The connected group of the convolutional layers of the ResNet network 111 and the corresponding group of the convolutional layers of the FPN network 112 correspond and/or process a feature map with same resolution, in another word, they receive same resolution of inputted feature map. Therefore, each group of convolutional layers of the FPN network 112 performs an up-sampling process and the resolutions of feature map processed and outputted by the groups from the ConvP2 to the ConvP5 are gradually increased.

In general, the output of the first group of convolutional layers Conv1 of the ResNet network 111, as an input group, is not connected to a corresponding group of convolutional layers of the FPN network 112, since the input group of the ResNet network 111 may provide insufficient data or information to be performed for feature extraction. Therefore, the number of groups of the convolutional layers of the FPN network 112 is smaller than the number of groups of the convolutional layers of the ResNet network 111, for example, the group of the Conv1 has no corresponding group of convolutional layers in the FPN network 112 as shown in FIG. 1.

The input of each of the ResNet-FPN networks is the multi-view 2D image(s) captured by cameras, and the outputs of the ResNet-FPN networks are multi-view 2D features with different resolutions corresponding to the groups of the convolutional layers of the FPN networks 112, each of which corresponds to the multi-view 2D images of Camera1 to Camera N in respective scales of resolution. Thus, the ResNet-FPN networks are 2D feature extraction networks based on multi-view 2D images.

The outputs of the multi-view 2D feature extraction module 110 are then inputted to the 3D feature volume generation module 120 which is configured to generate a 3D feature volume based on the multi-view 2D features.

The 3D feature volume generation module 120 further comprises a 3D feature volume pyramid generation unit 121 configured to generate a 3D feature volume pyramid 121-2 based on the extracted multi-view 2D features from the ResNet-FPN networks, and a 3D feature volume generation unit 122 configured to generate a final version of the 3D feature volume 123 based on the 3D feature volume pyramid 121-2.

The 3D feature volume pyramid generation unit 121 firstly generates a 2D feature pyramid 121-1 based on the extracted multi-view 2D features from the ResNet-FPN networks. Since the outputs of the ResNet-FPN networks are multi-view 2D features with different resolutions corresponding to the groups of the convolutional layers of the FPN network 112, the system according to the exemplary embodiment of the disclosure constructs a pyramid structure of 2D feature pyramid P2D with a plurality of 2D feature elements, i.e., P2D={P2-2D, P3-2D, P4-2D, P5-2D}. The number of the 2D feature elements corresponds to the number of the groups of the convolutional layers of the FPN network 112 with respective resolution scale, for example, in FIG. 1, the 2D feature pyramid 121-1 has four elements of the P2-2D to P2-5D which correspond to the four groups of the ConvP2 to ConvP5, so that the 2D feature pyramid 121-1 represents the multi-view 2D features in different resolution scales. As mentioned above, each of the elements in the 2D feature pyramid 121-1 which corresponds to respective output by the groups of the convolutional layers of the FPN network 112 with respective resolution is the set of multi-view 2D features of the plurality of stereo view cameras, thereby it can be represented as a set of extracted multi-view 2D features outputted by respective FPN network 112 for processing the feature map with same resolution, and the number of the extracted multi-view 2D features corresponds to the number of the plurality of stereo view cameras. For example, element P2-2D is the set of multi-view 2D features in resolution scale of ¼ original resolution of the multi-view image(s) captured by the Camera1 to Camera N. If the system has two stereo view cameras, each 2D feature element of the 2D pyramid 121-1 is a pair of multi-view 2D features.

Then the 3D feature volume pyramid generation unit 121 converts each of the 2D feature element into a 3D feature volume by applying an inverse-projection and a plane-sweep algorithm according to an embodiment of the disclosure, as indicated by reference number of 121-3 in FIG. 1. The multi-view 2D features of the 2D feature elements in the 2D pyramid 121-1, i.e., all of the multi-view 2D features in the sets of multi-view 2D features with same resolution, are applied to an inverse-projection from image frustrum coordinate system to Cartesian 3D coordinate system. Next, the 3D coordinates of each of the projected multi-view 2D features are applied by a plane-sweep algorithm to construct to a 3D feature volume. Since N stereo view cameras have N view angles with different parallaxes (disparity for binocular vision), the multi-view 2D features cannot be combined into a 3D feature easily and simply. In the application of the plane-sweep algorithm, the multi-view 2D features of the Camera1 to CameraN are applied to an inverse-projection in different scales of depth (distance between the camera and a 3D location) feature to construct one 3D feature volume based on these 2D features. The multiple scales of depth are, for example, 1 meter, 10 meters, 100 meters, etc. According to an embodiment of the disclosure, the plane-sweep algorithm uses even depths, for example, performs the projection every 10 meter. Such application of multi-scale feature makes the 3D object detection and segmentation for stereo vision system without an explicit decoder for semantic segmentation. For the 2D feature elements in the 2D feature pyramid 121-1, each of them is used for constructing a 3D feature volume which comprises a 3D features corresponding to the N stereo view cameras of the Camera1 to CameraN, for respective resolution scale. The plane-sweep algorithm also needs the intrinsic matrix and extrinsic matrix of the stereo view cameras. The dimensions of the intrinsic and extrinsic matrices of the stereo view cameras (such as, 4×4) are relative to the properties of the cameras. The 3D feature volume can be constructed based on the multi-view 2D features of the 2D feature elements and the intrinsic and extrinsic matrices of the respective one of the stereo view cameras, by applying an inverse-projection and a plane-sweep algorithm. In some embodiments, the plane-sweep algorithm can be replaced by Cost Volume method.

After the construction for 3D feature volumes, a 3D feature volume pyramid 121-2 can be generated based on the resulting 3D feature volumes. Similar to the 2D feature pyramid 121-1, the 3D feature volume pyramid 121-2 comprises a plurality of 3D feature volume elements and each of them is the 3D feature volume converted from the respective 2D feature element of the 2D feature pyramid 121-1. As shown in FIG. 1, the 3D feature volume pyramid 121-2, P3D={P2-3D, P3-3D, P4-3D, P5-3D}, has four 3D feature volume elements P2-3D, P3-3D, P4-3D, and P5-3D each of which corresponds to the 2D feature elements P2-2D, P3-2D, P4-2D, and P5-2D respectively. Each of the 3D feature volume elements is a 3D feature volume of the plurality of stereo view cameras with same resolution respectively. For example, the element P2-3D is the 3D feature volume in resolution scale of ¼ original resolution of the multi-view image(s) captured by the Camera1 to CameraN. If the system has two stereo view cameras, each 3D feature element of the 3D feature volume pyramid 121-2 is a 3D feature volume generated from the pair of multi-view 2D features represented by the 2D feature element P2-2D.

In order to obtain more 3D information, an inverse-projection is applied to transform the features from the image frustrum coordinate system to a Cartesian 3D coordinate system. It should be noted that such inverse-projection process allows the system infrastructure to easily identify and segment “floating” 3D object, such as the traffic lights, road signs, and other 3D object over the ground, and the overlapped 3D objects in the stereo view 2D images. In addition, the multiple-view projection process also supports the anchor-free manner in the 3D object detection.

The 3D feature volume generation unit 122 comprises a plurality of 3D Hourglass networks 122-P2 to 122-P5 to receive and process each of the 3D feature volume elements. Each of the 3D Hourglass network corresponds to a resolution as same as the resolution of the corresponding 3D feature volume element of the 3D feature volume pyramid 121-2, such that the number of the 3D Hourglass networks is identical to the number of the 3D feature volume elements. For example, the 3D Hourglass network 122-P2 receives and processes the 3D feature volume P2-3D because they correspond to same resolution. In some examples, the 3D Hourglass networks are lightweight 3D Hourglass networks.

The plurality of the 3D Hourglass networks 122-P2 to 122-P5 are aggregated by an aggregation algorithm 122-2 respectively to generate a final version of 3D feature volume 123. The resolution of the final version of the 3D feature volume 123 is adjustable and depends on the calculation performance configuration. For example, the dimensions of the multi-view 2D images are width and height and the dimensions of 3D image feature volume are width, height, and depth, then the resolution of the final version of the 3D feature volume 123 can be the ¼ of the original resolution, i.e., the width and height of the final version of 3D feature volume 123 is ¼ of the width and height of the multi-view 2D images captured by the stereo view cameras. The reduced resolution of feature map can reduce the calculation amount and increase the 3D object detection and segmentation speed without affecting the accuracy if it is selected properly.

Now turning to the right part of FIG. 1, the 3D object detection and segmentation module 130 comprises a depth estimation network 131, a semantic segmentation network 132, and a 3D object detection network 133 which are connected in parallel and share the final version of the 3D feature volume 123 as inputs. In some examples, the three networks of the 3D depth estimation network 131, the semantic segmentation network 132, and the 3D object detection network 133 can be operated substantially simultaneously to perform a simultaneous 3D object detection and segmentation. The parallel connection configuration, in particular, the simultaneous operation, is calculation friendly since parallel processing can reduce the calculation amount more than a sequence processing.

The depth estimation network 131 comprises a group of 3D convolutional layers, a Softmax layer, and a Soft Argmax layer which are connected in sequence. The group of the 3D convolutional layers are configured to generate 3D feature map based on the final version of 3D feature volume 123 from the 3D feature volume generation module 120. The Softmax layer is used for generating the depth estimations with different scales of depth (distance) based on the 3D feature map outputted from the group of 3D convolutional layer. In the plane-sweep algorithm as applied in the 3D feature volume generation module 120, the multi-view 2D features are projected in different scales of depth, such as even depth, thereby the Softmax layer outputs the depth estimation in the corresponding scales of depth and this depth may not be the accurate depth estimation. The Soft Argmax layer sets different weights for the different scales of depth as used in the Softmax layer so as to output a weighted depth estimation based on sum of the depth estimations having different weights.

The semantic segmentation network 132 comprises a group of reshape layers, a 2D convolutional layer, and a Softmax layer which are connected in sequence. Since the final version of the 3D feature volume 123 is a 3D feature information and the semantic segmentation is carried out on a 2D feature map, the dimensionality of 3D feature information is reduced into two (2D) for simplifying the calculation. The group of the reshape layers is configured to convert the depth dimensional feature of the final version of the 3D feature volume 123 into a non-dimensional feature, so that the output of the group of the reshape layers is a 2D feature of width and height, together with the non-dimensional feature of converted depth feature, as the 2D feature map input of the following 3D convolutional layer. Next, the 2D convolutional layer processes the residual two-dimensional features of the 3D feature volume, i.e., width and height, and the non-dimensional feature converted from depth to generate an output of types of semantic segmentation with respect to the multi-view 2D image(s) captured by the cameras. The Softmax layer outputs the information on which semantic segmentation type each pixel in the multi-view image(s) belongs to, based on the quantized semantic segmentation types outputted by the 2D convolutional layer.

According to an embodiment of the disclosure, the output of the depth estimation with different depth scales by the Softmax layer of the depth estimation network 131 can also be fed into the input of the 2D convolutional layer of the semantic segmentation network 132, as another non-dimensional feature to facilitate the semantic segmentation network 132 outputting a more accurate result.

The 3D object detection network 133 is configured to generate a classification, a centroid prediction and shape regression of the 3D object as three aspects of the output. The 3D object detection network 133 can detect and segment the “floating” 3D object in the multi-view 2D images in an anchor-free manner. Since the inverse-projection from the image frustrum coordinate system to the Cartesian 3D coordinate system in the 3D feature volume pyramid generation unit 121 may be performed in different views, such as front-view projection, top-view projection, etc., the heads for prediction would have more freedom to detect and segment the 3D object from the feature map of the multi-view images, especially for edge detection and segmentation.

In one embodiment of the disclosure, a 3D Hourglass network can be placed between the final version of the 3D feature volume 123 and the 3D object detection network 133 to perform feature extraction based on the 3D feature volume 123 prior to the inputting layer of the 3D object detection network 133. The 3D Hourglass network may also be a prior part of the 3D object detection network 133. The insertion of the 3D Hourglass network can optimize effect of the 3D object detection and segmentation of network 133. In some examples, the 3D Hourglass network can be replaced by a CenterNet network.

According an embodiment of the disclosure, the overall hybrid 2D and 3D CNN model system may further comprise a post-processing module 140 to provide a 3D instance segmentation result by determining which 3D object a pixel of the multi-view images belongs to, based on the 3D semantic segmentation results outputted by the semantic segmentation network 132 and the 3D object detection and the segmentation results outputted by the 3D object detection network 133. A pixel belongs to an object A, if this pixel is of the identical class (semantic segmentation) as the object A is and is spatially contained (depth estimation) in the 3D bounding box (3D object detection) of the object A, and vice versa.

Below is the introduction on the network training and inference.

The hybrid 2D and 3D CNN model system can be trained in an end-to-end manner. Firstly, the training data set of the multi-view 2D images having 3D object, depth, and segmentation annotations is provided. The following description is based on the exemplary system with binocular cameras that capture binocular image pairs, and this example is only illustrative but not limitation to the disclosure. The ordinary technicians would easily expand the example to those systems with stereo view cameras more than two.

It is assumed that the intrinsic and extrinsic matrices of the binocular cameras are known. In the depth estimation network 131, the loss of depth estimation is defined as following Smooth L1 Loss function:

$${L}_{depth} = \frac{1}{N} {\sum }_{i = 1}^{N} L {1}_{smooth} ( {d}_{i} - {d}_{GT , i} ) \qquad ( 1 )$$

where Nis the number of pixels in a depth feature map, dᵢ is the depth value of ith pixel, and d_{GT,i} is the real depth value of ith pixel as annotated in the training data set.

The semantic segmentation in the semantic segmentation network 132 is supervised by a cross-entropy loss function, according to an embodiment of the disclosure.

For the 3D object detection network 133, the 3D object classification branch uses a Focal Loss function as a supervision function and the 3D object centroid prediction branch uses a binary cross-entropy (BCE) loss function. For the loss of 3D object shape regression branch, the Smooth L1 Loss function is used for the regression of 3D bounding box:

$${L}_{3 Dreg} = \frac{1}{{N}_{obj}} {\sum }_{i = 1}^{{N}_{obj}} centerness ( {p}_{i} , {p}_{GT , i} ) \times L {1}_{smooth} ( {s}_{i} , {s}_{GT , i} ) \qquad ( 2 )$$

where N_{obj} is the number of 3D objects in current sample, pᵢ is the position (denoted as (x, y, z) in the Cartesian coordinate system) of ith 3D bounding box and sᵢ is the shape (denoted as (width, height, length (or depth))) of ith 3D bounding box. p_{GT,i} and s_{GT,i} are the real position and real shape of ith 3D bounding box as annotated in the training data set, respectively. In some embodiments, the shape of the 3D bounding box can further include the rotation information on the 3D object (denoted as (roll, pitch, yaw)). Different from the L1 Smooth Loss function in equation (1), the L1 Smooth Loss function in equation (2) is applied to the 3D multi-view feature map.

Function centerness(pᵢ, p_{GT,i}) is formulated as:

centerness(pᵢ,p_{GT,i})=exp[−norm(∥pᵢ,p_{GT,i}∥₂)] (3)

where function norm (·) denotes the min-max normalization. The total loss is a weighted summation of all loss terms above.

In the 3D object detection network 133, the BCE Loss function is used and cannot be replaced by other loss function, and the Focal Loss function is used but can be replaced by other loss function providing similar functionality.

Depth estimation, semantic segmentation, and 3D object detection are then trained, for example, trained substantially simultaneously, in an end-to-end manner. The weight training process for the multi-view stereo vision system is similar. In an embodiment of the disclosure, the key difference between the weight training processes of the binocular stereo vision system and of the multi-view stereo vision system is that the feature extractor for the multi-view system can be expanded with weight-sharing multi-stream feature extraction CNN networks, such as, multiple ResNet-50s. In the weight-sharing multi-stream feature extraction network, the trained weights of the two branches, i.e., the ResNet-FPN networks including the ResNet network 111 and the FPN network 112 for Input1 by Camera1 and for Input2 by Camera2 in FIG. 1, with respect to the binocular stereo vision system can be shared and copied to other ResNet-FPN network(s) which is newly added for the added camera(s) in the multi-view stereo vision system. In an embodiment, the trained weights of one of the two ResNet-FPN networks of the feature extractor for the binocular stereo vision system can also be shared and copied to another ResNet-FPN network. Furthermore, the feature extractors of the ResNet-FPN networks can share the trained weights with each other to fasten the training process and reduce the calculation amount. In the context, multi-stream means the data streams of a plurality of cameras of the multi-view stereo vision system.

After the hybrid 2D and 3D CNN model system is trained and the weights are stored, the apparatus and system for 3D object detection and segmentation based on stereo vision can detect and segment 3D objects in a binocular stereo vision system at same time. The trained hybrid 2D and 3D CNN model system with loaded weights is deployed on a suitable computation processor or device (e.g., an FPGA (field-programmable gate array) or a GPU (graphics processing unit)) and then the binocular image pairs captured by the binocular stereo vision camera system are fed. The system then gives the estimated depth, the semantic segmentation, and a set of 3D bounding boxes contains all the detected objects in the captured image pair. For the multi-view stereo vision system with more than two cameras, the application is similar.

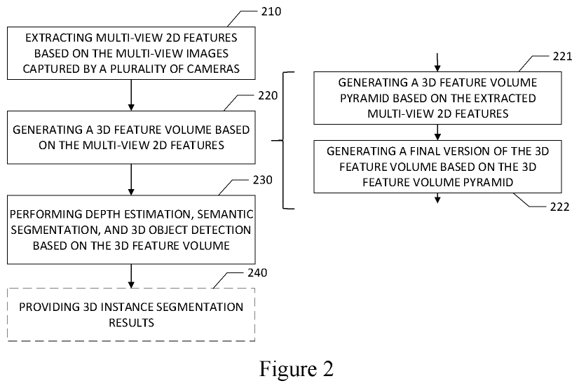

FIG. 2 shows an exemplary flow chart of the method for 3D object detection and segmentation based on stereo vision according to an embodiment of the disclosure.

The method comprises three main steps 210 to 230 generally.

In step 210, the method extracts multi-view 2D features based on the multi-view images (Input1 to InputN) captured by a plurality of cameras, Camera1 to CameraN. The extraction of the multi-view 2D features can be performed by two or more ResNet-FPN networks with feature extraction. The structure of the ResNet-FPN networks is discussed with reference to the hybrid 2D and 3D CNN model system above, so that it is not repeated.

In step 220, the method generates a 3D feature volume based on the multi-view 2D features. Step 220 comprises two sub-steps of 221 and 222. The sub-step 221 generates a 3D feature volume pyramid 121-2 based on the extracted multi-view 2D features from the ResNet-FPN networks and then the sub-step 222 generates a final version of the 3D feature volume 123 based on the 3D feature volume pyramid 121-2 as generated in the sub-step 221. The sub-step 221 can be divided into following detail steps: 1) a 2D feature pyramid 121-1 is generated based on the extracted multi-view 2D features, wherein the 2D feature pyramid 121-1 comprises a plurality of 2D feature elements, each of the 2D feature elements is a set of extracted multi-view 2D features outputted by respective FPN networks 112 for processing the feature map with same resolutions respectively, and the number of the extracted multi-view 2D features corresponds to the number of the plurality of cameras, such as N; 2) each of the plurality of 2D feature elements in the 2D feature pyramid 121-1 is converted into a 3D feature volume; and 3) a 3D feature volume pyramid 121-2 is generated based on the 3D feature volumes, wherein the 3D feature volume pyramid 121-2 comprises a plurality of 3D feature volume elements each of which is the 3D feature volume converted from respective 2D feature element of the 2D feature pyramid 121-1.

In the conversion from the 2D feature elements to the 3D feature volumes, each of the 2D feature elements is applied to an inverse-projection from an image frustrum coordinate system to a Cartesian 3D coordinate system, and then the 3D feature volume is constructed by applying a plane-sweep algorithm based on the world 3D coordinates of each of the 2D feature elements and based on the intrinsic and extrinsic matrices of respective one of the plurality of cameras.

In the sub-step 222, the method uses 3D Hourglass networks 122-P2 to 122-P5 corresponding to the same resolution of the 3D feature volume elements to process each of the 3D feature volume elements, respectively. In order to obtain a final version of the 3D feature volume 123, the sub-step 222 further aggregates the 3D Hourglass networks 112-P2 to 112-P5 in sequence. The aggregation algorithms or processes 122-2 between every two adjacent 3D Hourglass networks 122-P2 to 122-P5 can be same or similar algorithms or processes or different ones.

In the step 230, the depth estimation, semantic segmentation, and 3D object detection are performed based on the 3D feature volume. In some example, the depth estimation, semantic segmentation, and 3D object detection are performed substantially simultaneously. The detail structures of the depth estimation network 131, the semantic segmentation network 132, and the 3D object detection network 133 are introduced above and would not be repeated.

According to an embodiment of the disclosure, the method for 3D object detection and segmentation may further comprise a post-processing step 240 to provide 3D instance segmentation results, as shown by the block with dashed line in FIG. 2.

In some examples, the method for 3D object detection and segmentation can train the hybrid 2D and 3D CNN network before use it. After the neutral network is trained, the method can receive multi-view images captured by a plurality of cameras of the Camera1 to CameraN, and use the trained neutral network to perform the steps as shown in FIG. 2 as mentioned above.

The performance of the method, apparatus, and system for 3D object detection and segmentation according to the disclosure is tested on KITTI-like dataset. Table 1 shows the experimental result comparison between the provided solution of the disclosure and the existed network solutions.

TABLE 1
The performance comparison

| | Depth | | | | Runtime |
|---|---|---|---|---|---|
| | Estimation | Semantic | 3D Object | 3D Instance | (ms) |
| | ADO (lower | Segmentation | Detection | Segmentation | (lower is |
| Solution | is better) | mIoU | AP | AP | faster) |
| Provided | 2.28% | 88.5% | 80.3% | 35.0% | 427 |
| solution | | | | | |
| DSGN | 2.32% | Not provided | 70.9% | Not provided | 382 |
| PANet | Not provided | 81.4% | Not provided | 37.5% (only | 351 |
| | | | | 2D) | |
| DSGN + PANet | 2.32% | 81.4% | 70.9% | 30.6% | 811 |

In the table, ADO (lower is better) in depth estimation stands for percentage of stereo disparity outliers in the frame averaged over all ground truth pixels, mIoU (higher is better) in semantic segmentation is the mean value of per class intersection over union, and AP (higher is better) in 3D object detection and 3D instance segmentation is the average precision. Runtime (ms) (lower is faster) indicates the calculation speeds of the comparing networks.

DSGN network can perform a series of functionalities of 2D feature extraction, 3D feature volume generation, and 3D object detection, but it is only applied to the 3D object on the ground. Therefore, DSGN network cannot perform 3D instance segmentation and the results for semantic segmentation and 3D instance segmentation by DSGN network are not provided in the table. PANet network is a pure 2D CNN network for 2D semantic segmentation and 2D instance segmentation, such that it cannot provide any functionality of 3D object detection and the results relating to 3D detection in Table 1 for PANet are not provided either.

Since DSGN network and PANet network cannot provide all of the tests, they are combined into a DSGN+PANet network to finish the experiment. It can be seen from Table 1 that the provided solution of the disclosure has an ADO of 2.28%, a mIoU of 88.5%, an AP with overlap of 70% for 3D object detection, an AP of 35.0% for 3D instance segmentation, and a runtime of 427 ms. Although the runtime of the provided solution is slower than DSG network and PANet network which are used singly (427 ms vs 382 ms/351 ms), it is remarkably faster than the combined network based on these networks for full functionalities as provided by the solution of the disclosure alone. All metrics of the solution of the disclosure outperforms prior methods based on stereo vision system, and is competitive to those of some LiDAR-based methods.

The method, apparatus, and system for 3D object detection and segmentation as provided in the disclosure have many advantages and improvements in comparison to the conventional approaches at least in following aspects. Firstly, the accomplishment for 3D object instance detection and segmentation with single system is more practical to deploy on autonomous robots, vehicles, and mobile devices than existed solutions. Secondly, the CNN network used in the hybrid 2D and 3D CNN network model is a unified multi-task model instead of a long sequential pipeline used in prior methods. The parallel configuration can provide a substantial simultaneous 3D object instance detection and segmentation, for example. This manner saves computation and exploits the mutual benefits brought by jointly prediction those closely related results. Thirdly, the solutions of the disclosure are scalable when the number of cameras increases and is flexible to detect both indoor and outdoor 3D objects with effective training samples.

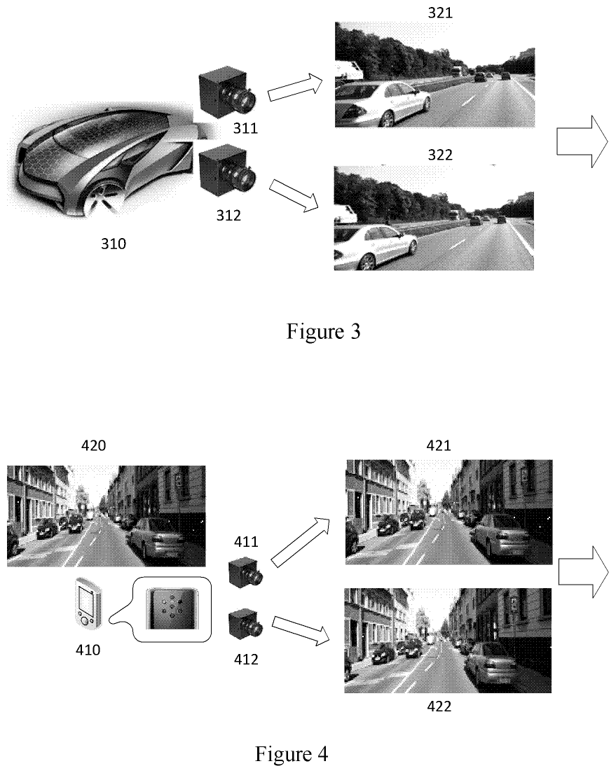

FIG. 3 illustrates an exemplary application in a vehicle 310, e.g. an autonomous vehicle, based on an embodiment of the disclosure. The vehicle 310 has a stereo vision capturing system with at least two cameras 311 and 312. The cameras can be mounted at left and right sides of the frontside of the vehicle 310, such as at the both sides of front bumper, on/behind the air intake barrier, and/or on/behind the windshield. The cameras can also be mounted at the sidewall of the vehicle 310, and/or the backside of the vehicle 310. The stereo vision capturing system can also use cameras of a panoramic image system to capture the multi-view images. The cameras 311 and 312 capture a pair of images, e.g. binocular view images 321 and 322, for example, in front of the vehicle 310 and input them into the hybrid 2D and 3D CNN model system 100 for 3D object detection and segmentation mounted in the vehicle 310 to perform 3D object instance detection and segmentation, which can be further used in an autonomous driving control in the vehicle 310, and/or displaying information on augmented, virtual and/or mixed reality display systems or applications in the vehicle 310. The 3D object detection and segmentation apparatus or system can be mounted, for example, as a module (such as one of driving assistance modules) or a circuitry in the control system for the vehicle 310, or as a function module in the control system to be executed by an electronic control unit (ECU). The vehicle 310 can also be unmanned surface vehicles, drones, robots, vessels or other devices/machines/systems requiring 3D object detection and segmentation. The stereo vision capturing system with the at least two cameras 311 and 312 can also be implemented in a fixed/stationary setting or system, such as a traffic monitoring system, an environment surveillance system, on an industrial process monitoring/management system.

FIG. 4 shows another application in an end user device or a client device 410, such as a mobile phone, for 3D object detection and segmentation based on stereo vision according to an embodiment of the disclosure. The user may hold the mobile phone 410 with a plurality of backside cameras, such as cameras 411 and 412, in a real world scene. The cameras 411 and 412 of the mobile phone 410 can be used to capture the multi-view images 421 and 422 of the real world scene 420 respectively. The plurality of the cameras can be placed at opposite edges or perimeters of the body frame of the mobile phone. The mobile phone 410 may be installed an application to perform 3D object detection and segmentation functions based on the multi-view images captured by the camera. The user can obtain the detection and segmentation results outputted by the application and/or send the results to other applications in the mobile phone and/or remote servers/web sites over cellular network or wireless network, for example. The 3D object detection and segmentation results can be used, for example, to augmented, virtual and/or mixed reality display systems or applications, in surveillance, information and advertisement delivery, and other applications. In one example, the device 410 can be attached to, used in and/or implemented in the vehicle 310. In an embodiment of the disclosure, the end user device or the client device 410 can also be one of mobile communication device, personal digital assistant (PDA), laptop, tablet computer, pad, notebook, one or more camera devices, one or more video camera devices, kinetic sensor device, video doorbell, IoT (Internet of things) device, or other mobile devices with stereo vision capturing system which comprises at least one, preferable more than two, multi-view cameras, or any combination thereof.

The present disclosure also provides an apparatus for 3D object detection and segmentation. The apparatus comprises at least one processor and at least one memory including computer program code. The at least one memory and the computer program code are configured to, with the at least one processor, cause the apparatus at least to perform the steps of the method for 3D object detection and segmentation as described above. For example, the steps comprise: receive 2D multi-view images captured by a plurality of cameras of the Camera1 to CameraN, use a trained neural network stored in the at least one memory at least to: extract multi-view 2D features based on the 2D multi-view images, generate a 3D feature volume based on the multi-view 2D features, and perform a depth estimation, a semantic segmentation, and a 3D object detection based on the 3D feature volume, for example, as shown in FIG. 2. The specific steps and sub-steps of the method and the trained neutral network has already illustrated above and will not be repeated.

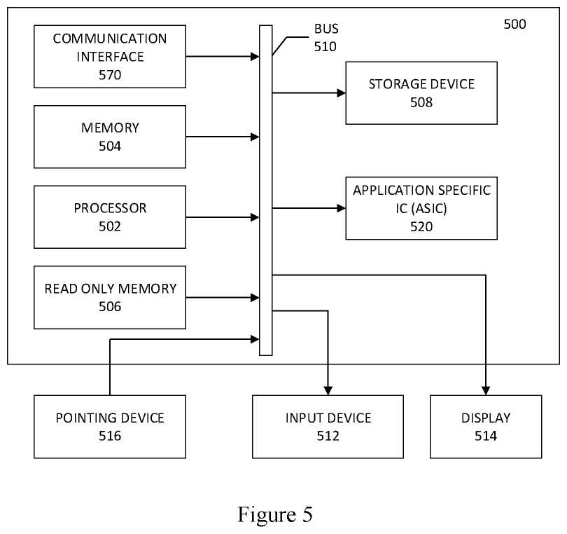

FIG. 5 illustrates a computer system, an apparatus or a circuitry 500 upon which an exemplary embodiment of the disclosure can be implemented. The computer system, apparatus, and/or circuitry 500 can also be considered as a more complete and detailed form of the apparatus for 3D object detection and segmentation as discussed in the previous paragraph. Although computer system, apparatus, and/or circuitry 500 is depicted with respect to a particular device or equipment, such as the vehicle 310, the electronic control unit (ECU), an autonomous driving control unit, a driving assistance module, the end user/client device 410, or any combination thereof, it is contemplated that other devices or equipment (e.g., network elements, servers, etc.) within FIG. 5 can deploy various means, such as the illustrated hardware and components of system 500. In some examples, the system 500 is a server or edge computer to implement the 3D object detection and segmentation process, which can also receive image/video data from external cameras via a wireless and/or wireline communication network. Computer system, apparatus, and/or circuitry 500 is designed and is programmed (e.g., via computer program code or instructions) for 3D object detection and segmentation as described herein and includes a communication means, such a communication mechanism of a bus 510 for passing information between other internal and external components of the computer system, apparatus, and/or circuitry 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. Computer system, apparatus, and/or circuitry 500, or a portion thereof, constitutes a means for performing one or more steps of security and trust technologies and solutions in virtualized networks.

In the description, the term “circuitry” as used may refer to one or more or all of the following: (a) hardware-only circuit implementations (such as implementations in only analog and/or digital circuitry) and (b) combinations of hardware circuits and software, such as (as applicable), and (c) hardware circuit(s) and or processor(s), such as a microprocessor(s) or a portion of a microprocessor(s), that requires software (e.g., firmware) for operation, but the software may not be present when it is not needed for operation. The combinations of hardware circuits and software includes: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions). This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

A bus 510 includes one or more parallel conductors of information so that information is transferred quickly among devices coupled to the bus 510. One or more data processing means, such as processors 502 for processing information are coupled with the bus 510.

A processor 502 performs a set of operations on information as specified by one or more computer program code related to the 3D object detection and segmentation as described herein. The computer program code is a set of instructions or statements providing instructions for the operation of the one or more processors and/or the computer systems to perform specified functions. The code, for example, can be written in a computer programming language that is compiled into a native instruction set of the processor. The code can also be written directly using the native instruction set (e.g., a machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors can be implemented as mechanical, electrical, magnetic, optical, chemical or quantum components, among others, alone or in combination.

The computer system, apparatus, and/or circuitry 500 also includes one or more data storage means, such as a memory 504 coupled to the bus 510. The memory 504, such as a random access memory (RAM) or other dynamic storage device, stores information including processor instructions for 3D object detection and segmentation as described herein. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes one or more read only memories (ROMs) 506 or other static storage devices coupled to the bus 510 for storing static information, including instructions, that is not changed by the computer system 500. Some memory is composed of volatile storage that loses the information stored thereon when power is lost. Also coupled to the bus 510 is one or more non-volatile (persistent) storage devices 508, such as a magnetic disk, optical disk or flash card, for storing information, including instructions, that persists even when the computer system 500 is turned off or otherwise loses power.

Data or information for the 3D object detection and segmentation process as described herein, is provided via the bus 510 for use by the one or more processors and one or more memory devices from one or more imaging devices, such as the cameras 311, 312, 411 and/or 412, or the Camera1 to the CameraN.

Information, including instructions for the 3D object detection and segmentation as described herein, is provided to the bus 510 for use by the one or more processors from one or more external input devices 512, such as a keyboard containing alphanumeric keys operated by a human user, or a sensor. Other external devices coupled to the bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, one or more special purpose hardware, such as an application specific integrated circuit (ASIC) 520, is coupled to the bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware. Other example can include an FPGA (field-programmable gate array) or a GPU (graphics processing unit).

Computer system, apparatus, and/or circuitry 500 also includes one or more means for data communication, such as instances of a communications interface 570 coupled to the bus 510. Communication interface 570 provides a one-way or two-way communication coupling to a variety of external devices that operate with their own processors, such as printers, scanners, external disks, sensors, and cameras. In general, the coupling is with a network link that is connected to a local network to which a variety of external devices with their own processors are connected. For example, communication interface 570 can be a parallel port or a serial port or a universal serial bus (USB) port on a personal computer. In some embodiments, communications interface 570 is an integrated service digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 can be a local area network (LAN) card to provide a data communication connection to a compatible LAN, such as Ethernet. Wireless links can also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communication interface 570 includes a radio band electromagnetic transmitter and receiver called a radio transceiver. In certain implementations, the communication interface 570 enables wireless short-range connection, such as Bluetooth, WLAN (wireless local area network) and/or UWB (ultra-wide band). In certain implementations, the communication interface 570 enables cellular telecommunication connection, such 5G (5th generation) cellular network. In certain implementations, the communication interface 570 enables connection to virtualized networks for decentralized trust evaluation in a distributed network as described herein.

The term “computer-readable medium” as used herein refers to any medium that participates in providing information to processor 502, including instructions for execution. Such a medium can take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

At least some embodiments of the disclosure are related to the use of computer system, apparatus, and/or circuitry 500 for implementing some or all of the techniques described herein. According to one embodiment of the disclosure, those techniques are performed by computer system, apparatus, and/or circuitry 500 in response to processor 502 executing one or more sequences of one or more processor instructions contained in memory 504. Such instructions, also called computer instructions, software and program code, can be read into memory 504 from another computer-readable medium such as storage device 508 or network link. Execution of the sequences of instructions contained in memory 504 causes processor 502 to perform one or more of the method steps described herein. In alternative embodiments, hardware, such as ASIC 520, can be used in place of or in combination with software to implement the invention. Thus, embodiments of the invention are not limited to any specific combination of hardware and software, unless otherwise explicitly stated herein.

The signals transmitted over network link and other networks through communications interface 570, carry information to and from computer system, apparatus, and/or circuitry 500. Computer system, apparatus, and/or circuitry 500 can send and receive information, including program code, through the networks, through communications interface 570. The received code can be executed by processor 502 as it is received, or can be stored in memory 504 or in storage device 508 or other non-volatile storage for later execution, or both. In this manner, computer system 500 can obtain application program code in the form of signals on a carrier wave.

The disclosure includes any novel feature or combination of features disclosed herein either explicitly or any generalization thereof. Various modifications and adaptations to the foregoing exemplary embodiments of this disclosure can become apparent to those skilled in the relevant arts in view of the foregoing description, when read in conjunction with the accompanying drawings. However, any and all modifications will still fall within the scope of the non-limiting and exemplary embodiments of this disclosure.

1.-47. (canceled)

48. A method comprising:
extracting multi-view 2D features based on multi-view images captured by a plurality of cameras;
generating a 3D feature volume based on the multi-view 2D features; and
performing a depth estimation, a semantic segmentation, and a 3D object detection based on the 3D feature volume.

49. The method according to claim 48, wherein the extracting of the multi-view 2D features based on the multi-view images captured by the plurality of the cameras is performed by two or more ResNet-FPN (feature pyramid network) networks with feature extraction.

50. The method according to claim 49, wherein each of the ResNet-FPN networks comprises a ResNet network and a corresponding FPN network and is configured to extract a multi-view 2D feature based on multi-view images captured by respective one of the plurality of the cameras.

51. The method according to claim 50, wherein an output of each group of convolutional layers of the ResNet network is connected to an input of corresponding group of convolutional layers of the corresponding FPN network for processing a feature map with same resolution as the group of convolutional layers of the ResNet network.

52. The method according to claim 48, wherein generating the 3D feature volume based on the multi-view 2D features further comprise:
generating a 3D feature volume pyramid based on the extracted multi-view 2D features; and
generating a final version of the 3D feature volume based on the 3D feature volume pyramid.

53. The method according to claim 48, wherein performing the depth estimation, the semantic segmentation, and the 3D object detection based on the 3D feature volume by a depth estimation network, a semantic segmentation network and a 3D object detection network which are connected in parallel and share the 3D feature volume as inputs.

54. The method according to claim 53, wherein the depth estimation network comprises:
a group of 3D convolutional layers configured to generate a 3D feature map;
a Softmax layer configured to output depth estimations in different depth scales based on the 3D feature map; and
a Soft Argmax layer configured to generate a weighted depth estimation from the depth estimations in different depth scales.

55. The method according to claim 53, wherein the semantic segmentation network comprises:
a group of reshape layers configured to convert the depth feature of the 3D feature volume into a non-dimensional feature;
a 2D convolutional layer configured to output segmentation types based on the residual two-dimensional features of the 3D feature volume together with the non-dimensional feature; and
a Softmax layer configured to output the segmentation type for each pixel in the multi-view images.

56. The method according to claim 53, wherein the 3D object detection network is configured to generate a classification, a centroid prediction and a shape regression of the 3D object.

57. The method according to claim 48, wherein the method is implemented on at least one of: an vehicle, a drone, a robot, a mobile device, or a mobile communication device.

58. An apparatus for 3D object detection and segmentation, comprising:
at least one processor;
at least one memory storing instructions that, when executed by the at least one processor, cause the apparatus at least to:
receive multi-view images captured by a plurality of cameras;
use a trained neural network stored in the at least one memory at least to:
extract multi-view 2D features based on the multi-view images;
generate a 3D feature volume based on the multi-view 2D features; and
perform a depth estimation, a semantic segmentation, and a 3D object detection based on the 3D feature volume.

59. The apparatus according to claim 58, wherein the extract of the multi-view 2D features is performed by two or more ResNet-FPN (feature pyramid network) networks with feature extraction.

60. The apparatus according to claim 59, wherein each of the ResNet-FPN networks comprises a ResNet network and a corresponding FPN network and is configured to extract a multi-view 2D feature based on a multi-view image captured by respective one of the plurality of the cameras.

61. The apparatus according to claim 60, wherein an output of each group of convolutional layers of the ResNet network is connected to an input of corresponding group of convolutional layers of the corresponding FPN network for processing a feature map with same resolution as the group of convolutional layers of the ResNet network.

62. The apparatus according to claim 58, wherein the generation of the 3D feature volume further comprises:
generate a 3D feature volume pyramid based on the extracted multi-view 2D features; and
generate a final version of the 3D feature volume based on the 3D feature volume pyramid.

63. The apparatus according to claim 58, wherein the performing of the depth estimation, the semantic segmentation, and the 3D object detection based on the 3D feature volume by a depth estimation network, a semantic segmentation network and a 3D object detection network which are connected in parallel and share the 3D feature volume as inputs.

64. The apparatus according to claim 63, wherein the depth estimation network comprises:
a group of 3D convolutional layers configured to generate a 3D feature map;
a Softmax layer configured to output depth estimations in different depth scales based on the 3D feature map; and
a Soft Argmax layer configured to generate a weighted depth estimation from the depth estimations in different depth scales.

65. The apparatus according to claim 63, wherein the semantic segmentation network comprises:
a group of reshape layers configured to convert the depth feature of the 3D feature volume into a non-dimensional feature;
a 2D convolutional layer configured to output segmentation types based on the residual two-dimensional features of the 3D feature volume together with the non-dimensional feature; and
a Softmax layer configured to output the segmentation type for each pixel in the multi-view images.

66. The apparatus according to claim 58, wherein the plurality of cameras are mounted on one of: an vehicle, a drone, a robot, and a mobile device, or a mobile communication device.

67. A non-transitory computer-readable storage medium storing instructions which, when executed by an apparatus, cause the apparatus to perform a at least the following:
extracting multi-view 2D features based on multi-view images captured by a plurality of cameras;
generating a 3D feature volume based on the multi-view 2D features; and
performing a depth estimation, a semantic segmentation, and a 3D object detection based on the 3D feature volume.
